(19) United States
(12) Patent Application Publication
(10) Pub. No.: US 2024/0297697 A1
(43) Pub. Date: Sep. 5, 2024

(54) TRANSMISSION ACROSS PARTITIONED RESOURCE POOLS

(71) Applicant: QUALCOMM Incorporated, San Diego, CA (US)

(72) Inventors: Ahmed ELSHAFIE, San Diego, CA (US); Ahmed Attia ABOTABL, San Diego, CA (US); Marwen ZORGUI, San Diego, CA (US)

(21) Appl. No.: 18/177,722

(22) Filed: Mar. 2, 2023

(51) Int. Cl. H04B 7/06; H04B 1/713; H04L 5/00

(52) U.S. Cl. CPC H04B 7/0626; H04B 1/713; H04L 5/0051

(57) ABSTRACT

Apparatus, methods, and computer program products for wireless communication are provided. An example method may include communicating, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission. The example method may further include receiving, from the second network entity, the first CSI-RS transmission including a first instance of CSI-RS information based on the frequency hopping pattern. The example method may further include receiving, from the second network entity, the second CSI-RS transmission including a second instance of the CSI-RS information based on the frequency hopping pattern. The example method may further include transmitting, to the second network entity, a CSI report based on the first CSI-RS transmission or the second CSI-RS transmission.

### TECHNICAL FIELD

The present disclosure relates generally to communication systems, and more particularly, to wireless communication systems with sidelink communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus, which may be a first network entity, such as a first user equipment (UE), are provided. The apparatus may include a memory and at least one processor coupled to the memory. The at least one processor may be configured to communicate, with a second network entity, a repetition configuration associated with a first channel state information (CSI) reference signal (CSI-RS) transmission and a second CSI-RS transmission, where the repetition configuration includes information indicative of a frequency hopping pattern associated with the first CSI-RS transmission and the second CSI-RS transmission. The at least one processor may be configured to receive, from the second network entity, the first CSI-RS transmission including a first instance of CSI-RS information based on the frequency hopping pattern. The at least one processor may be configured to receive, from the second network entity, the second CSI-RS transmission including a second instance of the CSI-RS information based on the frequency hopping pattern. The at least one processor may be configured to transmit, to the second network entity, a CSI report based on the first CSI-RS transmission or the second CSI-RS transmission.

In another aspect of the disclosure, a method, a computer-readable medium, and an apparatus, which may be a first network entity, such as a base station, are provided. The apparatus may include a memory and at least one processor coupled to the memory. The at least one processor may be configured to communicate, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission. The at least one processor may be configured to transmit, for the second network entity, the first CSI-RS transmission including a first instance of CSI-RS information based on the frequency hopping pattern. The at least one processor may be configured to transmit, for the second network entity, the second CSI-RS transmission including a second instance of the CSI-RS information based on the frequency hopping pattern. The at least one processor may be configured to receive a CSI report based on the first CSI-RS transmission or the second CSI-RS transmission.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of CSI-RS transmission.

FIG. 5 is a diagram illustrating an example of bandwidth part (BWP) for different types of UEs.

FIG. 6 is a diagram illustrating example communications between a UE and a network entity.

FIG. 7 is a diagram illustrating an example of frequency hopping for CSI-RS transmissions.

FIG. 8 is a diagram illustrating an example of frequency hopping for CSI-RS transmissions.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

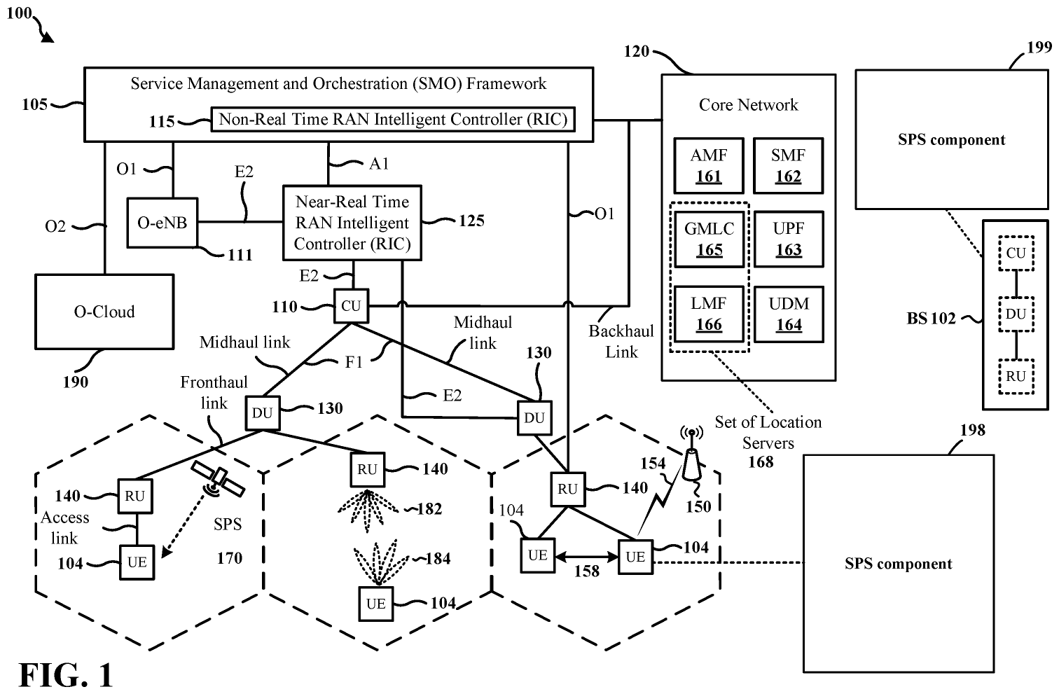

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like.

Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the

LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a repetition component 198. In some aspects, the repetition component 198 may be configured to communicate, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission. In some aspects, the repetition component 198 may be configured to receive, from the second network entity, the first CSI-RS transmission including a first instance of CSI-RS information based on the frequency hopping pattern. In some aspects, the repetition component 198 may be configured to receive, from the second network entity, the second CSI-RS transmission including a second instance of the CSI-RS information based on the frequency hopping pattern. In some aspects, the repetition component 198 may be configured to transmit, to the second network entity, a CSI report based on the first CSI-RS transmission or the second CSI-RS transmission.

In certain aspects, the base station 102 may include a repetition component 199. In some aspects, the repetition component 199 may be configured to communicate, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission. In some aspects, the repetition component 199 may be further configured to transmit, for the second network entity, the first CSI-RS transmission including a first instance of CSI-RS information based on the frequency hopping pattern. In some aspects, the repetition component 199 may be further configured to transmit, for the second network entity, the second CSI-RS transmission including a second instance of the CSI-RS information based on the frequency hopping pattern. In some aspects, the repetition component 199 may be further configured to receive a CSI report based on the first CSI-RS transmission or the second CSI-RS transmission.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

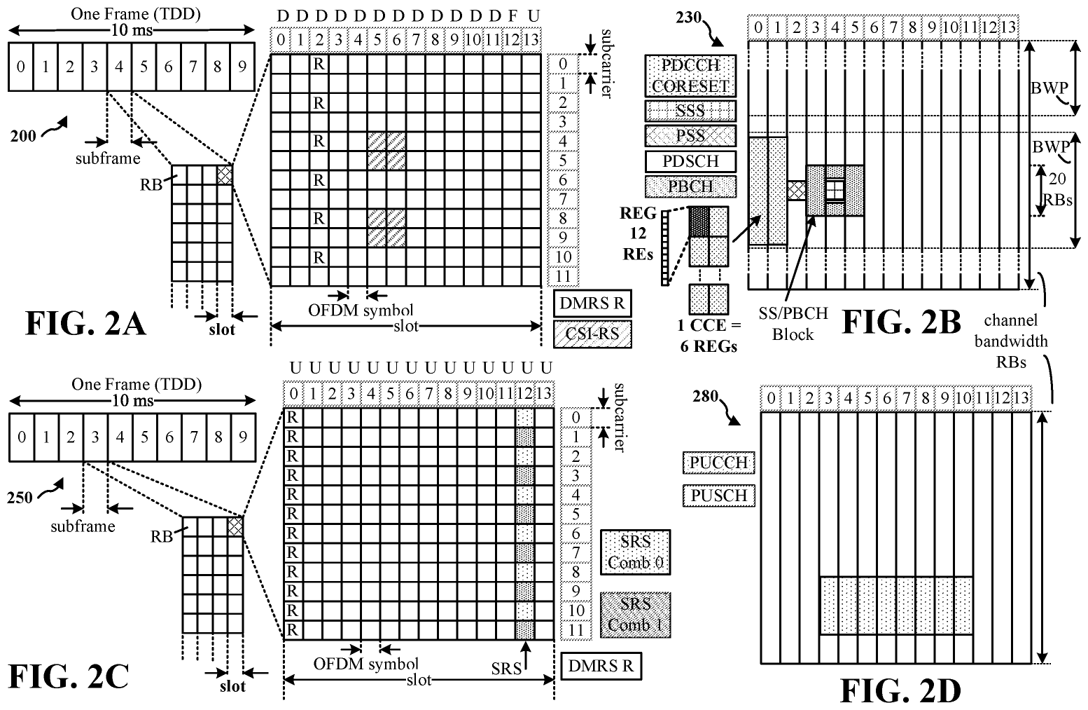

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies u 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}·15 kHz where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

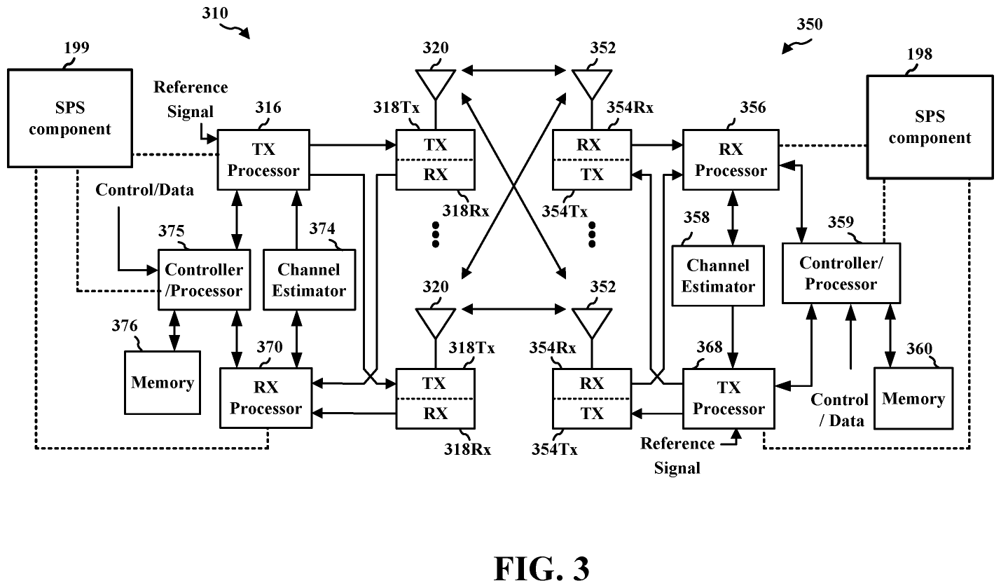

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with repetition component 198 of FIG. 1.

At least one of the TX processor 316, the RX processor 370, and the controller/processor 375 may be configured to perform aspects in connection with repetition component 199 of FIG. 1.

In addition to higher capability devices, wireless communication may support reduced capability (RedCap) devices (may otherwise be referred as reduced capability UE or RedCap UE). Among others, examples of higher capability devices include premium smartphones, V2X devices, URLLC devices, eMBB devices, etc. Among other examples, RedCap devices may include wearables, industrial wireless sensor networks (IWSN), surveillance cameras, low-end smartphones, etc. For example, NR communication systems may support both higher capability devices and reduced capability devices. A RedCap UE may be referred to as an NR light device, a low-tier device, a lower tier device, etc. Reduced capability UEs may communicate based on various types of wireless communication. For example, smart wearables may transmit or receive communication based on low power wide area (LPWA)/mMTC, relaxed IoT devices may transmit or receive communication based on URLLC, sensors/cameras may transmit or receive communication based on eMBB, etc.

In some examples, a reduced capability UE may have reduced transmission bandwidth or reception bandwidth than other UEs. For instance, a reduced capability UE may have a smaller bandwidth of 5 MHz or 20 MHz BWP in FR1 or 100 MHz in FR2. In some aspects, the reduced capability UE may have an operating bandwidth between 5 MHz and 20 MHz (such as 20 MHz) for both transmission and reception, in contrast to other UEs which may have a bandwidth of up to 100 MHz or more than 100 MHz. As a further example, a reduced capability UE may have a reduced number of reception antennas (e.g., 2 reception antennas) in comparison to other UEs that may have a larger number of reception antennas. For instance, a reduced capability UE may have a single receive antenna, or two receive antennas, and may experience a lower equivalent receive signal to noise ratio (SNR) in comparison to higher capability UEs that may have additional antennas. Reduced capability UEs may also have reduced computational complexity than other UEs. As reduced capability UEs may have 20 MHz BWP, if the number of reduced capability UEs served by a base station is large, these UEs may be assigned with different BWPs so that the cell traffic load may be balanced in a cell with a larger bandwidth. Reduced capability UEs may also have a reduced bandwidth for PDSCH or PUSCH and reduced peak data rate for FR1.

In some communication systems, to save frequency spectrum consumption, a common multicast message is sent to a group of reduced capability UEs (e.g., all the reduced capability UEs) in a certain 20 MHz BWP. Therefore, each reduced capability UE in a set of UEs may be assigned with two BWPs: one BWP for unicast, which may be different among different UEs; the other BWP for multicast, which is common for each of the UEs.

A reduced capability UE may have a smaller number of antennas. For example, example RedCap UE may have two Rx antennas that may be able to work in three modes: 1) two Rx antennas for unicast (mode A), 2) two Rx antennas for multicast (mode B), and 3) one Rx antenna for unicast and one Rx antenna for multicast (mode C). Because each of the group of UEs (whether at a cell center or a cell edge) receive the same multicast message, a low modulation and coding scheme (MCS) may be used by a base station to transmit the multicast in order to help ensure that UEs at the cell edge are able to successfully receive the multicast. However, for UEs that are closer to the transmitting cell, one Rx antenna may be sufficient to decode a message in the multicast transmission, and the lower MCS may lead to a low throughput for the closer UEs. Therefore, allowing simultaneous unicast and multicast reception at different frequency resources for reduced capability UE can increase the overall throughput and reduce the transmission latency for UEs that are closer to the transmitting cell (e.g., which may be referred to as cell center UEs). Therefore, in some wireless communication systems, the two BWPs for multicast and unicast may be active for the UE at overlapping times and the UE may receive concurrent transmissions in the two BWPs.

In some wireless communication systems, a network entity may schedule a UE to perform measurements (which may also be referred to as “sound” or “sounding”) on CSI-RS or CSI interference measurement (CSI-IM) resources with respect to various metrics (such as reference signal received power (RSRP), reference signal received quality (RSRQ), reference signal strength indicator (RSSI), signal-to-interference and noise ratio (SINR), channel quality indicator (CQI), or the like). Based on the measurement, the UE may transmit a CSI report on a PUSCH using an UL grant. A PDCCH transmission may be used to trigger the CSI report on the PUCCH.

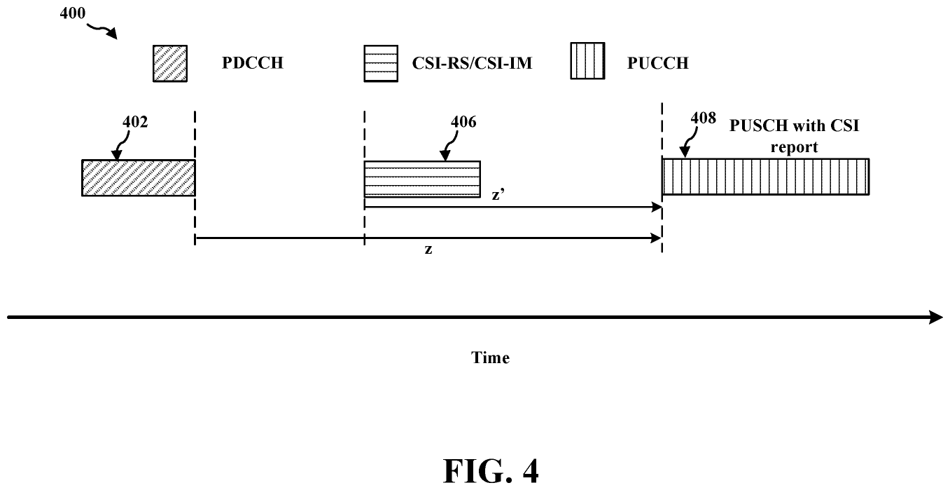

As illustrated in in example 400 in FIG. 4, a network entity may transmit a PDCCH 402 associated with a CSI-RS 406 (or CSI-IM resource) to a UE. In response to receiving the PDCCH 402, the UE may perform measurements and generate measurement information based on the CSI-RS 406, and transmit a CSI report in the PUSCH 408. As illustrated in FIG. 4, z may indicate the time difference between a last symbol of the PDCCH 402 and the PUSCH 408 with the CSI report. Further, z′ may indicate the time difference between a last symbol of the CSI-RS 404 and the PUSCH 408 with the CSI report. In some aspects, for mmW, there may be a time difference KB between the PDCCH 402 to beam switching. The maximum allowed values of z, z′, or KB may be configured and the UE and the network entity may communicate in a fashion such that the maximum allowed values of z, z′, or KB may be met (e.g., actual time differences being smaller than the maximum allowed values). Different maximum allowed values of z, z′, or KB may be configured for CSI reports for different metrics or different latencies.

As used herein, the term “repetition configuration” may refer to information related to receiving multiple instances of CSI-RS information. Repetition configuration may include a repetition indication, which may be indicative of the fact that multiple instances of CSI-RS information may be transmitted in different CSI-RS transmissions. Repetition configuration may also include information indicative of a frequency hopping pattern. As used herein, the term “CSI-RS information” may refer to information transmitted in a CSI-RS transmission from the network to a UE. A first instance of CSI-RS information may be transmitted in a first CSI-RS transmission and a second instance of the CSI-RS information (e.g., which may be a repetition) may be transmitted in a second CSI-RS transmission. As used herein, the term “frequency hopping” may refer to changing frequency and associated frequency resource pool (e.g., sub-band) between two transmissions. As an example, intra-slot frequency hopping may occur when there is a first transmission on a first mini-slot of the slot based on a first frequency resource pool (e.g., sub-band) and a second transmission on a second mini-slot of the same slot based on a second frequency resource pool (e.g., sub-band), where the first frequency resource pool differs from the second frequency resource pool. As another example, inter-slot frequency hopping may occur when there is a first transmission on a first slot based on a first frequency resource pool (e.g., sub-band) and a second transmission on a second slot based on a second frequency resource pool (e.g., sub-band), where the first frequency resource pool differs from the second frequency resource pool. As used herein, the term “frequency hopping pattern” may be used to refer to information regarding frequency differences between a first transmission and a second transmission. For example, a frequency hopping pattern may include information indicative of a first frequency resource pool (e.g., sub-band) for transmitting the first transmission and a second frequency resource pool (e.g., sub-band) for transmitting the second transmission. A frequency resource pool or sub-band may be associated with at least one frequency band. In another example, the frequency hopping pattern may be indicative of that the first transmission and the second transmission may be transmitted based on different frequencies. As used herein, the term “measurement information” may refer to generated measurement information with respect to a metric, such as RSRP, RSSI, RSRQ, SINR, or the like. As used herein, the term “hopping flag” may be information indicative of that there may be frequency hopping in at least two upcoming transmissions. A hopping flag may be transmitted from a network entity to a UE based on downlink control information (DCI), MAC control element (MAC-CE), radio resource control (RRC) signaling, or the like.

Some aspects provided herein may enable some UEs, such as reduced capability UEs with a 5 MHz broadband (BB) bandwidth and a 20 MHz RF bandwidth for UL and DL or reduced capability UEs with a 5 MHz bandwidth for PDSCH and PDSCH and a 20 MHz bandwidth for RF bandwidth, to more efficiently process CSI-RS transmissions or transmit CSI-RS reports. Based on aspects provided herein, intra-slot frequency hopping or inter-slot frequency hopping (e.g., which may be based on sub-bands in a bandwidth part (BWP) of the UE) may be used for CSI-RS transmissions. Aspects provided herein may also provide CSI reports based on sub-bands.

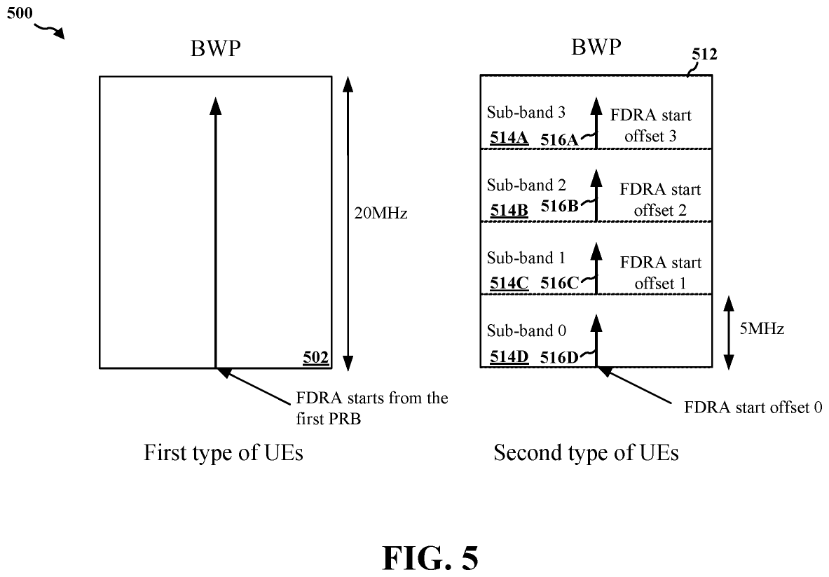

FIG. 5 is a diagram 500 illustrating an example of BWP for different types of UEs. As illustrated in FIG. 5, a first type of UEs, such as non-reduced capability UEs, may be associated with a BWP 502 where frequency domain (FD) resource allocation (RA) (FDRA) may start from a first PRB of the BWP. A second type of UEs, such as some type of reduced capability UEs, may be associated with a BWP 512 that may be partitioned into four sub-bands including a sub-band 514A, a sub-band 514B, a sub-band 514C, and a sub-band 514D. FDRA for each of the sub-band 514A, the sub-band 514B, the sub-band 514C, and the sub-band 514D may each respectively start after a FDRA start offset 516A, a FDRA start offset 516B, a FDRA start offset 516C, or a FDRA start offset 516D. The FDRA start offset associated with each respective sub-band may be determined based on a maximum UE bandwidth associated with the UE (e.g., a maximum number of RBs in the maximum UE bandwidth). In some aspects, a sub-band may be valid if the sub-band includes a configured number of RBs. In some aspects, the BWP may be partitioned based on a configuration from a network entity or based on a configuration without signaling. In some aspects, the start of FDRA for DL reception may be a first RB in a valid sub-band. Some aspects provided herein may facilitate efficient decision on determining which sub-band or set of sub-bands to use for DL and UL communications by utilizing CSI-RS transmissions that hops between the sub-bands.

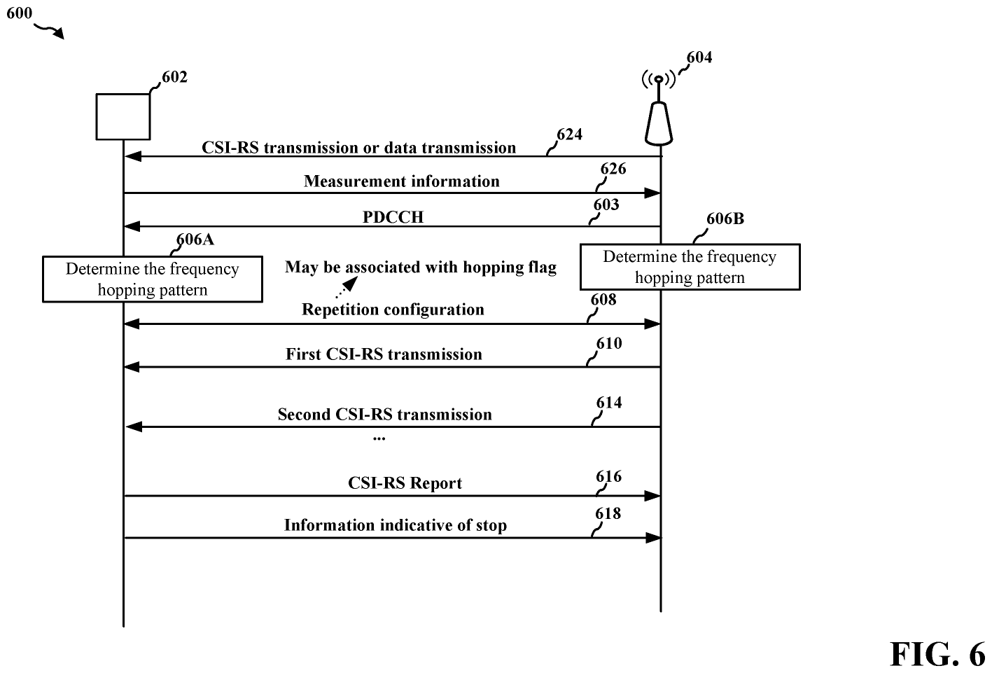

FIG. 6 is a diagram 600 illustrating example communications between a UE 602 and a network entity 604. To facilitate frequency hopping of CSI RS transmissions between the UE 602 and the network entity 604, a repetition configuration 608 may be communicated between the network entity 604 to the UE 602. In some aspects, the UE 602 may be a reduced capability UE. In some aspects, the UE 602 may be a non-reduced capability UE. In some aspects, the UE 602 may be an energy harvesting UE or a non-energy harvesting UE. In some aspects, the repetition configuration 608 may include a frequency hopping pattern or a repetition indication associated with a first CSI-RS transmission 610 and a second CSI-RS transmission 614 from the network entity 604 to the UE 602. In some aspects, the first CSI-RS transmission 610 may be based on a first sub-band and the second CSI-RS transmission 614 may be based on a second sub-band. In some aspects, the UE 602 may determine the frequency hopping pattern at 606A and transmit the repetition configuration 608 to the network entity 604 and the repetition configuration 608 may indicate a determined frequency hopping pattern and a set of associated sub-bands to sound (e.g., based on measurement information 626 generated based on a transmission 624, which may be a CSI-RS transmission or a data transmission that is earlier than the first CSI-RS transmission 610 or the second CSI-RS transmission 614). By configuring a frequency hopping pattern associated with CSI-RS transmission, the UE 602 may sound the sub-bands associated with the repetition configuration 608 and avoid sounding the entire RF band, which may in turn save power at the UE 602. In some aspects, the network entity 604 may determine the frequency hopping pattern at 606B and transmit the frequency hopping pattern in the repetition configuration 608 to the UE 602. In some aspects, the repetition configuration 608 may be associated with a hopping flag transmitted from the network entity 604 to the UE 602 to indicate that there may be frequency hopping between the first CSI-RS transmission 610 and the second CSI-RS transmission 614 (e.g., based on the frequency hopping pattern associated with the repetition configuration 608).

In some aspects, to determine the frequency hopping pattern and associated sub-bands, the UE 602 or the network entity 604 may determine the frequency hopping pattern such that the sub-bands used are of a difference larger than the maximum supported frequency difference. In some aspects, determine the frequency hopping pattern and associated sub-bands may be based on one or more IDs (e.g., indices) associated with the sub-bands or one or more IDs associated with time domain resources (e.g., which may be indicated by the PDCCH transmission 603 from the network entity 604 to the UE 602) for the CSI-RS transmission. For example, the UE 602 may determine to use a sub-band with lowest index for CSI-RS transmissions in odd-numbered slots or sub-slots and determine to use a sub-band with highest index for CSI-RS transmissions in even-numbered slots or sub-slots.

In some aspects, the frequency hopping pattern may define one or more particular patterns. For example, the frequency hopping pattern may define a pattern of {0, 1,2,3} where each number represent a sub-band. Based on the example pattern, if the first CSI-RS transmission 610 is based on sub-band 0, the second CSI-RS transmission may be based on sub-band 1. Based on the example pattern, if the first CSI-RS transmission 610 is based on sub-band 1, the second CSI-RS transmission may be based on sub-band 2. Based on the example pattern, if the first CSI-RS transmission 610 is based on sub-band 2, the second CSI-RS transmission 614 may be based on sub-band 3. Based on the example pattern, if the first CSI-RS transmission 610 is based on sub-band 3, the second CSI-RS transmission 614 may be based on sub-band 0. In some aspects, the frequency hopping pattern may define one or more different frequency patterns for different sub-bands used for the first CSI-RS transmission 610. For example, the frequency hopping pattern may define a pattern of {0, 1,2,3} if the first CSI-RS transmission 610 uses the sub-band 0 (where the second CSI-RS transmission 614 may be based on sub-band 1, a third CSI-RS transmission may be based on sub-band 2, a fourth CSI-RS transmission may be based on sub-band 3), define a pattern of {1,2,3,0} if the first CSI-RS transmission 610 uses the sub-band 1 (e.g., the second CSI-RS transmission 614 may be based on sub-band 2, a third CSI-RS transmission may be based on sub-band 3, a fourth CSI-RS transmission may be based on sub-band 0), or the like. In some aspects, the frequency hopping pattern may define a pattern where the sub-band used for transmitting a subsequent CSI-RS transmission is not adjacent to the sub-band used for transmitting the previous CSI-RS transmission. For example, the frequency hopping pattern may define a pattern of {0,3,1,2}, {1,3,0,2}, or the like. In some aspects, the frequency hopping pattern may be based on a maximum allowed frequency difference between consecutive CSI-RS transmissions, which may be configured for the UE 602 with or without signaling. In some aspects, the frequency hopping pattern may define that a first hop (e.g., sub-band used for the first CSI-RS transmission 610) may be based on a first valid sub-band or another valid sub-band configured for the UE 602.

In some aspects, the frequency hopping pattern may include patterns that may be determined and configured per report configuration associated with a CSI report 616 based on the first CSI-RS transmission 610 and the second CSI-RS transmission 614, per CSI-RS resource associated with the first CSI-RS transmission 610 and the second CSI-RS transmission 614, or per resource set associated with the first CSI-RS transmission 610 and the second CSI-RS transmission 614. In some aspects, a report configuration associated with the CSI report 616 may change based on which sub-bands are used for the first CSI-RS transmission 610 and the second CSI-RS transmission 614 or which sub-band is used for triggering the CSI report 616 (e.g., the PDCCH transmission 603 which may trigger the CSI report 616). In some aspects, a report configuration associated with the CSI report 616 may include different configurations associated with different sub-bands that may be used for triggering the report configuration.

In some aspects, the CSI report 616 may be of a particular type that includes different information, such as including at least one of: measurement information per each sub-band, measurement information per each set of sub-bands, measurement information across all sub-bands (e.g., wideband channel quality indication or rank indicator), measurement information per one or more sub-bands that may be redefined and repartitioned within a resource pool (e.g., repartition the measurement information based on sub-band partition for non-reduced capability UEs even if UE 602 is a reduced capability UE and the sub-bands for the frequency hopping pattern is defined base on sub-band partition for reduced capability UEs), measurement information for a quantity (which may be configured based on L1 signaling, L2 signaling, or L3 signaling) of best performing (e.g., highest metric) sub-bands for DL determined based on sounding the CSI-RS transmissions, measurement information for a quantity (which may be configured based on L1 signaling, L2 signaling, or L3 signaling) of worst performing (e.g., lowest metric) sub-bands for DL determined based on sounding the CSI-RS transmissions, or the like.

In some aspects, information in the CSI report 616, such as information regarding best and worst performing sub-bands, may be used by the network entity 604 to align or determine one or more sub-bands for communications between the UE 602 and the network entity 604 or communications between one or more other UEs and the network entity 604.

In some aspects, time delays associated with the first CSI-RS transmission 610 and the second CSI-RS transmission 614, the CSI report 616, and the PDCCH transmission 603 (which may be Z and Z′ explained in connection with FIG. 4) may be a function of sub-bands associated with the first CSI-RS transmission 610 and the second CSI-RS transmission 614 (and sounded by the UE 602), the quantity of subbands associated with the first CSI-RS transmission 610 and the second CSI-RS transmission 614, a starting sub-band associated with the first CSI-RS transmission 610, a type of the CSI report 616, whether frequency hopping was enabled for first CSI-RS transmission 610 and the second CSI-RS transmission 614, or a frequency hopping type associated with the first CSI-RS transmission 610 and the second CSI-RS transmission 614 (such as intra-slot frequency hopping or inter-slot frequency hopping).

In some aspects, the CSI report 616 may include a first measurement information associated with a first sub-band that includes the measured metrics associated with the first sub-band and include other measurement information associated with other sub-bands based on differences (e.g., delta values such as delta channel quality indicator (CQI)) between the measured metrics associated with the first sub-band and the other sub-bands. In some aspects, measurement information associated with different sub-bands in the CSI report 616 may be each associated with a respective priority. When the CSI report 616 may be multiplexed with another transmission and a part of the CSI report 616 may be dropped, the dropping may be performed based on the respective priority.

In some aspects, the UE 602 may transmit information indicative of stopping transmission of CSI-RS 618 to the network entity 604 and the network entity 604 may accordingly stop further transmission of CSI-RS. Because switching of digital bandwidth processing may consume energy, the UE 602 may enable power saving by transmit information indicative of stop transmission of CSI-RS 618 to the network entity 604. In some aspects, the UE 602 may transmit information indicative of stopping transmission of CSI-RS 618 to the network entity 604 after determining one or more sub-bands for further communications (which may be indicated in the CSI report 616). In some aspects, the UE 602 may determine one or more sub-bands for further communications based on measurement information associated with the one or more sub-bands, which may be sub-bands for the first CSI-RS transmission 610 and the second CSI-RS transmission 614.

In some aspects, the CSI report 616 may include filtered measurement information (such as RSRP, SINR, or RSRQ) across one or more sub-bands, which may be sub-bands for the first CSI-RS transmission 610 and the second CSI-RS transmission 614, or across different times for a same sub-band, which may be a sub-band for the first CSI-RS transmission 610 or the second CSI-RS transmission 614. In some aspects, the UE 602 may compute pathloss and transmit a powerhead room (PHR) report or other reports, based on the measurement information for the one or more bands.

In some aspects, the UE 602 may indicate, in the CSI report 616 or a different signaling, one or more particular sub-bands determined by the UE 602 to be suitable for data reception or transmission and one or more particular sub-bands determined by the UE 602 to be suitable for positioning (and associated measurement information or associated estimated accuracy for each of the one or more particular sub-bands).

In some aspects, the first CSI-RS transmission 610 and the second CSI-RS transmission 614 may be associated with a same time domain RA associated with different slots or mini-slots and may be based on different sub-bands. For example, with the same time domain resource allocation, the time difference between the first CSI-RS transmission 610 and a beginning of the slot or mini-slot associated with the first CSI-RS transmission 610 may be the same as a time difference between the second CSI-RS transmission 614 and a beginning of the slot or mini-slot associated with the second CSI-RS transmission 614. In some aspects, the first CSI-RS transmission 610 and the second CSI-RS transmission 614 may be associated with a same relative RB location (e.g., compared with a boundary of the respective sub-band).

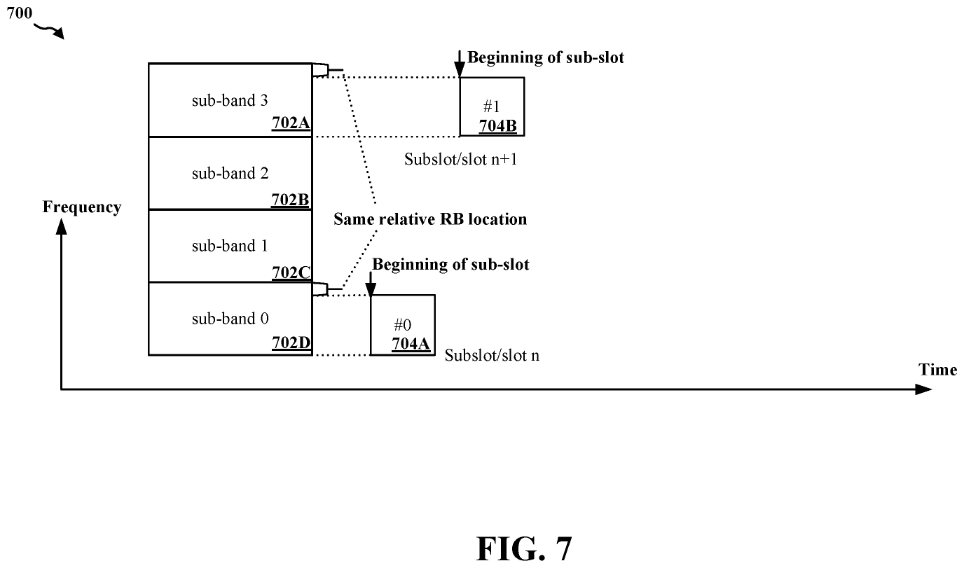

Referring now to FIG. 7, FIG. 7 is a diagram 700 illustrating an example of intra-slot frequency hopping for PSSCH. As illustrated in FIG. 7, there may be a total of four sub-bands including sub-band 3 702A, sub-band 2 702B, sub-band 1 702C, and sub-band 0 702D. The first CSI-RS transmission 610 may be based on the sub-band 0 702D in a first sub-slot or first slot 704A of index N. The second CSI-RS transmission 614 may be based on the sub-band 3 702A in a second sub-slot or second slot 704B of index N+1. As illustrated in FIG. 7, the relative RB location (in relation to the sub-band 0 702D) of the CSI-RS transmission in the first sub-slot or first slot 704A may be the same as the relative RB location (in relation to the sub-band 3 702A) of the CSI-RS transmission in the second sub-slot or second slot 704B. As illustrated in FIG. 7, the time domain allocation of CSI-RS transmission in the first sub-slot or first slot 704A may be the same as the CSI-RS transmission in the second sub-slot or second slot 704B (both at the beginning of the sub-slot).

In some aspects, the repetition configuration may include a frequency hopping pattern that indicates the allowed frequency differences between the first CSI-RS transmission and the second CSI-RS transmission. For example, the frequency hopping pattern may indicate an allowed sub-band index difference or corresponding allowed frequency difference between the sub-bands used for the first CSI-RS transmission and the second CSI-RS transmission. For example, the allowed sub-band index difference or corresponding allowed frequency difference may define a maximum allowed difference in one direction (e.g., positive) and another maximum allowed difference in another direction (e.g., negative). In some aspects, the allowed sub-band index difference or corresponding allowed frequency difference between the sub-bands used for the first CSI-RS transmission and the second CSI-RS transmission may be based on a capability of the receiving UE and selected by the transmitting UE. In some aspects, the allowed sub-band index difference or corresponding allowed frequency difference between the sub-bands used for the first CSI-RS transmission and the second CSI-RS transmission may be configured by the network.

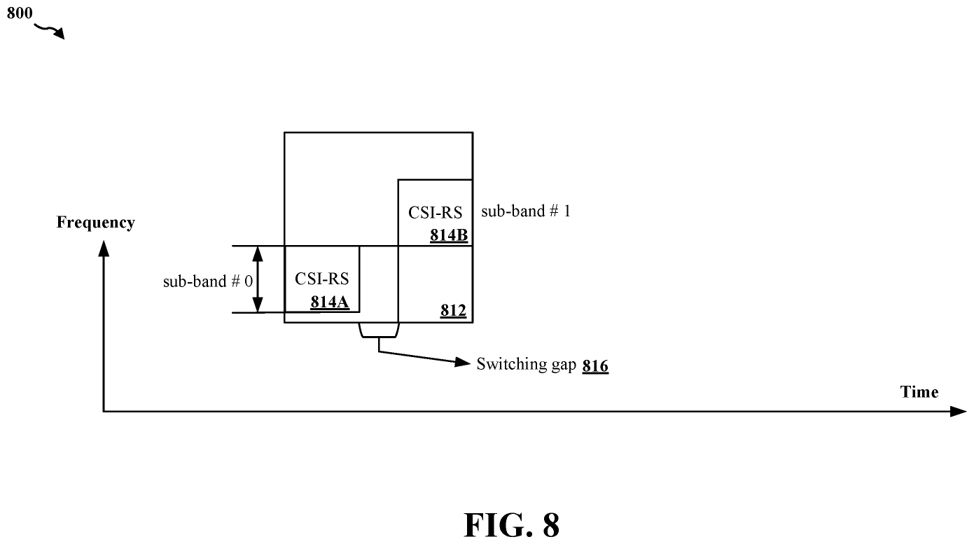

Referring now to diagram 800 in FIG. 8, in some aspects, to facilitate frequency hopping across different sub-bands, a switching time gap 816 may be introduced between a first CSI-RS transmission 814A and a second CSI-RS transmission 814B in a same slot 812. In some aspects, the switching time gap may be configured as one or more symbols at the beginning of the time domain allocation after hopping (e.g., right before the second CSI-RS transmission).

In some aspects, the switching time gap may be configured as one or more symbols at the end of the time domain allocation before hopping (e.g., right after the first CSI-RS transmission).

In some aspects, the switching time gap may be configured (e.g., by the network entity 604) based on RRC signaling, DCI, MAC-CE, configured using other layer 1 (L1) signaling, layer 2 (L2) signaling, or layer 3 (L3) signaling, configured during initial access, or configured without signaling. In some aspects, the switching time gap may be defined per resource pool, per sub-band, per multiple sub-bands, or the like. In some aspects, the switching time gap may be based on sub-band size. In some aspects, if the switching time gap may overlap with one or more symbols in the CSI-RS transmission, the one or more symbols in the CSI-RS transmission may be punctured or rate-matched. In some aspects, the switching time gap may be based on RF tuning, a sub-band associated with the first CSI-RS transmission or a next sub-band associated with the second CSI-RS transmission, an energy state of the receiving UE, or the like. As used herein, the term “energy state” (which may also be referred to as “energy mode,” “energy information,” or “energy status”) may refer to one or more of: an energy level profile representing available energy at a device's energy storage unit or battery over time based on current measurements and prediction over time (e.g., current available energy, predicted future available energy and associated predicted time instances or durations, or the like), an energy charging profile representing an energy charging rate or other energy charging related parameters related to the device's energy storage unit or battery (e.g., a current energy charging rate, predicted future energy charging rates and associated predicted time instances or durations, or the like), an energy discharging profile representing an energy discharging rate (e.g., a current energy discharging rate, predicted future energy discharging rates and associated predicted time instances or durations, or the like), or other energy discharging related parameters related to the device's energy storage unit or battery. For example, an energy charging profile may include a current measured charging rate, how long the current charging rate is predicted to last, a predicted charging rate for one or more future time instances or durations, or the like. As one example, the energy charging profile may include P1, P2, P3, P4, . . . , PN (each of which represent an energy charging rate and T1 (time instance or duration predicted for charging rate P1 to last), T2 (time instance or duration predicted for charging rate P2 to last), T3 (time instance or duration predicted for charging rate P3 to last), T4 (time instance or duration predicted for charging rate P4 to last), . . . , TN (time instance or duration predicted for charging rate PN to last). In some aspects, based on an agreement with two wireless devices (such as a UE and a gNB or between two UEs), a wireless device may decide based on the profiles (e.g., and the values in each profile including P1, P2, . . . , PN, the parameters, T1, T2, . . . , TN) for each profile of the energy charging profile, the energy discharging profile, or the energy level profile.

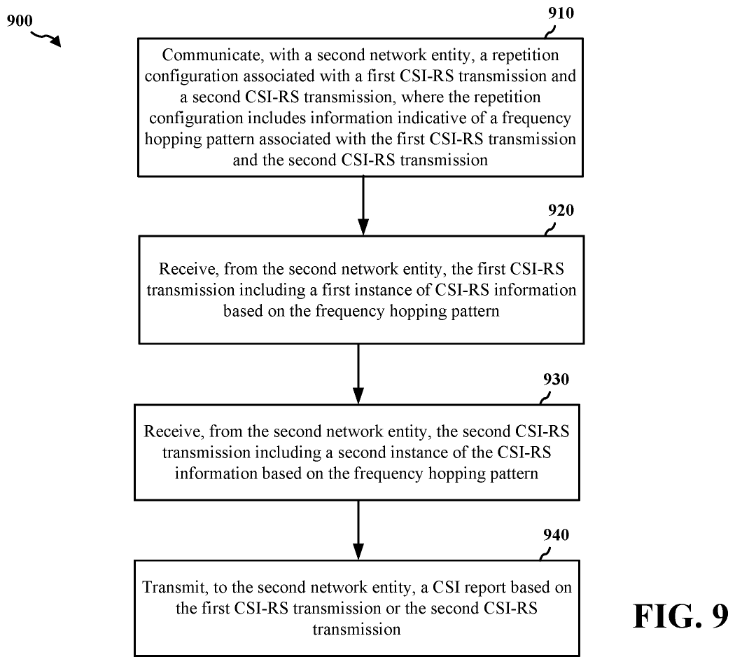

FIG. 9 is a flowchart 900 of a method of wireless communication. The method may be performed by a first network entity, such as a UE (e.g., the UE 104, the UE 602; the apparatus 1204).

At 910, the UE may communicate, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission. For example, the UE 602 may communicate, with a second network entity, a repetition configuration 608 associated with a first CSI-RS transmission 610 and a second CSI-RS transmission 614, where the repetition configuration includes information indicative of a frequency hopping pattern associated with the first CSI-RS transmission and the second CSI-RS transmission. In some aspects, 910 may be performed by repetition component 198.

At 920, the UE may receive, from the second network entity, the first CSI-RS transmission including a first instance of CSI-RS information based on the frequency hopping pattern. For example, the UE 602 may receive, from the second network entity (e.g., network entity 604), the first CSI-RS transmission 610 including a first instance of CSI-RS information based on the frequency hopping pattern. In some aspects, 920 may be performed by repetition component 198. In some aspects,

At 930, the UE may receive, from the second network entity, the second CSI-RS transmission including a second instance of the CSI-RS information based on the frequency hopping pattern. For example, the UE 602 may receive, from the second network entity (e.g., network entity 604), the second CSI-RS transmission 614 including a second instance of the CSI-RS information based on the frequency hopping pattern. In some aspects, 930 may be performed by repetition component 198.

At 940, the UE may transmit, to the second network entity, a CSI report based on the first CSI-RS transmission or the second CSI-RS transmission. For example, the UE 602 may transmit, to the second network entity (e.g., network entity 604), a CSI report 616 based on the first CSI-RS transmission 610 or the second CSI-RS transmission 614. In some aspects, 940 may be performed by repetition component 198.

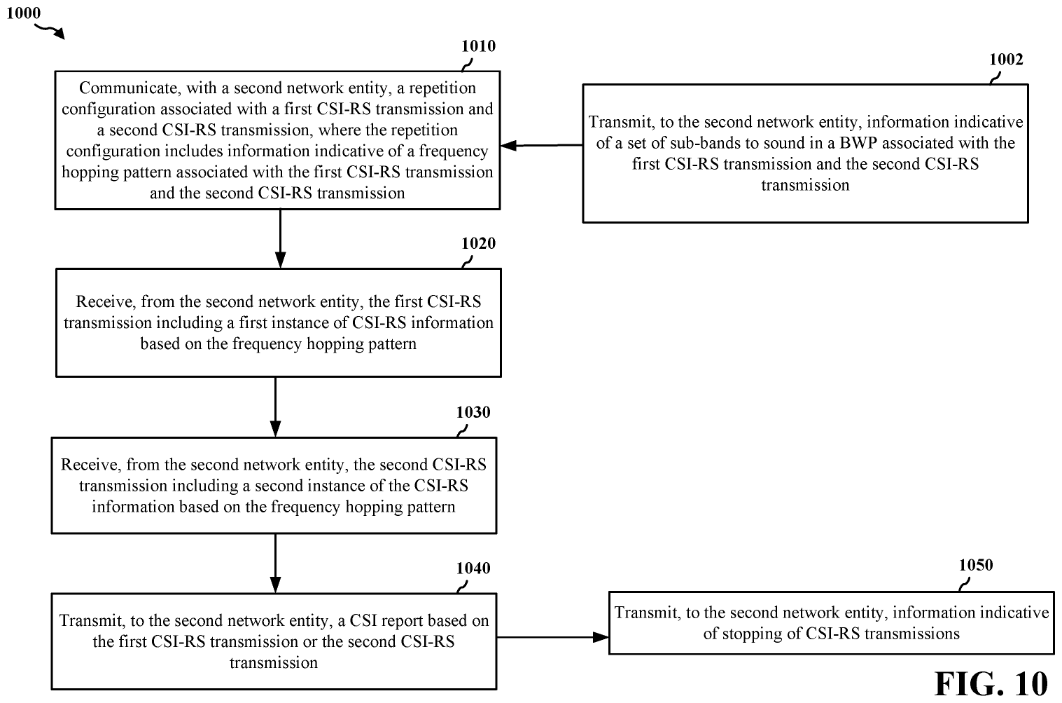

FIG. 10 is a flowchart 1000 of a method of wireless communication. The method may be performed by a first network entity, such as a UE (e.g., the UE 104, the UE 602; the apparatus 1204).

At 1002, the UE may transmit, to the second network entity, information indicative of a set of sub-bands to sound in a BWP associated with the first CSI-RS transmission and the second CSI-RS transmission. For example, the UE 602 may transmit, to the second network entity, information indicative of a set of sub-bands to sound in a BWP associated with the first CSI-RS transmission 610 and the second CSI-RS transmission 614. In some aspects, 1050 may be performed by repetition component 198.

At 1010, the UE may communicate, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission. For example, the UE 602 may communicate, with a second network entity, a repetition configuration 608 associated with a first CSI-RS transmission 610 and a second CSI-RS transmission 614, where the repetition configuration includes information indicative of a frequency hopping pattern associated with the first CSI-RS transmission and the second CSI-RS transmission. In some aspects, 1010 may be performed by repetition component 198. In some aspects, to communicate the repetition configuration, the UE may transmit, to the second network entity, the repetition configuration. The UE may also transmit, to the second network entity, information indicative of a set of sub-bands to sound in a BWP associated with the first CSI-RS transmission and the second CSI-RS transmission, where the repetition configuration and the set of sub-bands are based on measurement information based on a third CSI-RS transmission or a data communication (e.g., 624), where the third CSI-RS transmission or the data communication is based on at least one sub-band of the set of sub-bands. In some aspects, to communicate the repetition configuration, the UE may receive, from the second network entity via downlink control information (DCI), radio resource control (RRC) signaling, or medium access control (MAC) control element (MAC-CE), the repetition configuration.

At 1020, the UE may receive, from the second network entity, the first CSI-RS transmission including a first instance of CSI-RS information based on the frequency hopping pattern. For example, the UE 602 may receive, from the second network entity (e.g., network entity 604), the first CSI-RS transmission 610 including a first instance of CSI-RS information based on the frequency hopping pattern. In some aspects, 1020 may be performed by repetition component 198.

At 1030, the UE may receive, from the second network entity, the second CSI-RS transmission including a second instance of the CSI-RS information based on the frequency hopping pattern. For example, the UE 602 may receive, from the second network entity (e.g., network entity 604), the second CSI-RS transmission 614 including a second instance of the CSI-RS information based on the frequency hopping pattern. In some aspects, 1030 may be performed by repetition component 198. In some aspects, to receive the first CSI-RS transmission, the UE may receive the first CSI-RS transmission in a first sub-band in a BWP. In some aspects, to receive the second CSI-RS transmission, the UE may receive the second CSI-RS transmission in a second sub-band in the BWP. In some aspects, to receive the first CSI-RS transmission, the UE may receive the first CSI-RS transmission based on a time domain RA. In some aspects, to receive the second CSI-RS transmission, the UE may receive the second CSI-RS transmission based on the time domain RA. In some aspects, to receive the first CSI-RS transmission, the UE may receive the first CSI-RS transmission in a relative RB location in the first sub-band. In some aspects, to receive the second CSI-RS transmission, the UE may receive the second CSI-RS transmission in the relative RB location the second sub-band.

In some aspects, the UE may determine the first sub-band based on a first index associated with the first sub-band and determine the second sub-band based on a second index associated with the second sub-band. In some aspects, a first one of the first index or the second index is a highest index associated with the BWP, and where a second one of the first index or the second index is a lowest index associated with the BWP. In some aspects, to determine the second sub-band based on the second index, the UE may determine the second index based on the first index and the frequency hopping pattern. In some aspects, to determine the second sub-band based on the second index, the UE may determine the second index based on the first index and the frequency hopping pattern. In some aspects, the first sub-band is a first valid sub-band, and where, to determine the second sub-band based on the second index, and the UE may determine the second sub-band based on the first index and an index difference between the first index and the second index.

In some aspects, the repetition configuration is configured per a CSI report configuration, per a CSI resource, or per a CSI resource set. In some aspects, the CSI report is based on a sub-band configured for triggering the CSI report. In some aspects, the CSI report is of a type including CSI information of at least one of: per a sub-band, per a set of sub-bands, across all sub-bands, or per one or more subset of subbands based on one or more metrics associated with the one or more subset of subbands being higher than or lower than one or more thresholds. I

At 1040, the UE may transmit, to the second network entity, a CSI report based on the first CSI-RS transmission or the second CSI-RS transmission. For example, the UE 602 may transmit, to the second network entity (e.g., network entity 604), a CSI report 616 based on the first CSI-RS transmission 610 or the second CSI-RS transmission 614. In some aspects, 1040 may be performed by repetition component 198. In some aspects, a first time difference between the first CSI-RS transmission and the CSI report or a second time difference between DCI scheduling the first CSI-RS transmission and the CSI report is based on at least one of: a first sub-band associated with the first CSI-RS transmission, a second sub-band associated with the second CSI-RS transmission, the type associated with the CSI report, or the frequency hopping pattern. In some aspects, the CSI report includes first measurement information associated with a first sub-band associated with the first CSI-RS transmission and second measurement information associated with a second sub-band associated with the second CSI-RS transmission, where the second measurement information is based on a difference from the first measurement information. In some aspects, the CSI report includes first measurement information associated with a first sub-band associated with the first CSI-RS transmission and second measurement information associated with a second sub-band associated with the second CSI-RS transmission, where a first priority is associated with the first measurement information and a second priority is associated with the second measurement information. In some aspects, the CSI report includes first measurement information associated with a first sub-band associated with the first CSI-RS transmission and second measurement information associated with a second sub-band associated with the second CSI-RS transmission, where the first measurement information or the second measurement information is filtered. In some aspects, the CSI report includes information indicative of data transmission metric or positioning metric associated with each sub-band associated with the first CSI-RS transmission and the second CSI-RS transmission.

In some aspects, the UE may determine, based on measurement information associated with a particular sub-band associated with the first CSI-RS transmission and the second CSI-RS transmission, the particular sub-band. In some aspects, at 1050, the UE may transmit, to the second network entity, information indicative of stopping of CSI-RS transmissions. For example, the UE 602 may transmit, to the second network entity, information (e.g., 618) indicative of stopping of CSI-RS transmissions. In some aspects, 1050 may be performed by repetition component 198.

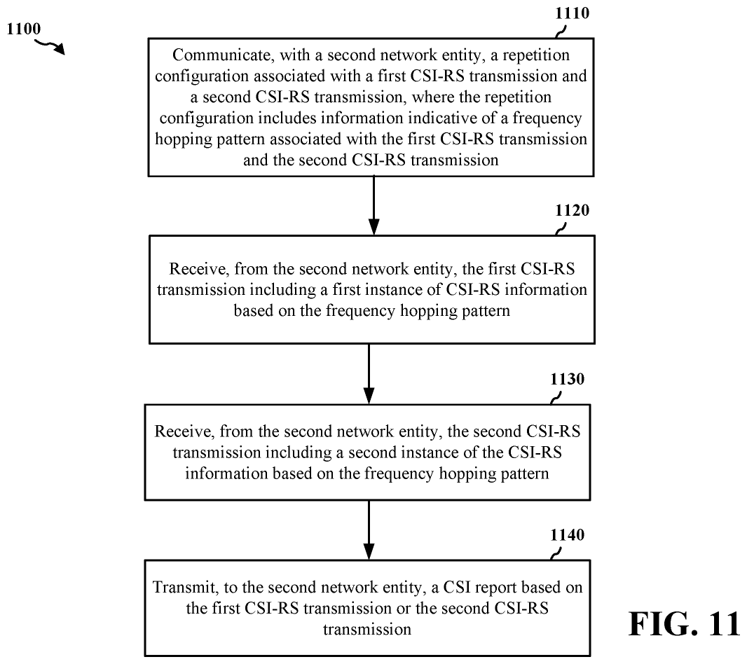

FIG. 11 is a flowchart 1100 of a method of wireless communication. The method may be performed by a network entity (e.g., the base station 102, the network entity 604, the network entity 1202, the network entity 1302).

At 1110, the network entity may communicate, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission. For example, the network entity 604 may communicate, with a second network entity (e.g., the UE 602), a repetition configuration 608 associated with a first CSI-RS transmission 610 and a second CSI-RS transmission 614, where the repetition configuration includes information indicative of a frequency hopping pattern associated with the first CSI-RS transmission and the second CSI-RS transmission. In some aspects, 1110 may be performed by repetition component 199.

At 1120, the network entity may transmit, for the second network entity, the first CSI-RS transmission including a first instance of CSI-RS information based on the frequency hopping pattern. For example, the network entity 604 may transmit, for the second network entity (e.g., the UE 602), the first CSI-RS transmission 610 including a first instance of CSI-RS information based on the frequency hopping pattern. In some aspects, 1120 may be performed by repetition component 199.

At 1130, the network entity may transmit, for the second network entity, the second CSI-RS transmission including a second instance of the CSI-RS information based on the frequency hopping pattern. For example, the network entity 604 may transmit, for the second network entity (e.g., the UE 602), the second CSI-RS transmission 614 including a second instance of the CSI-RS information based on the frequency hopping pattern. In some aspects, 1130 may be performed by repetition component 199.

At 1140, the network entity may receive a CSI report based on the first CSI-RS transmission or the second CSI-RS transmission. For example, the network entity 604 may receive a CSI report 616 based on the first CSI-RS transmission or the second CSI-RS transmission. In some aspects, 1140 may be performed by repetition component 199.

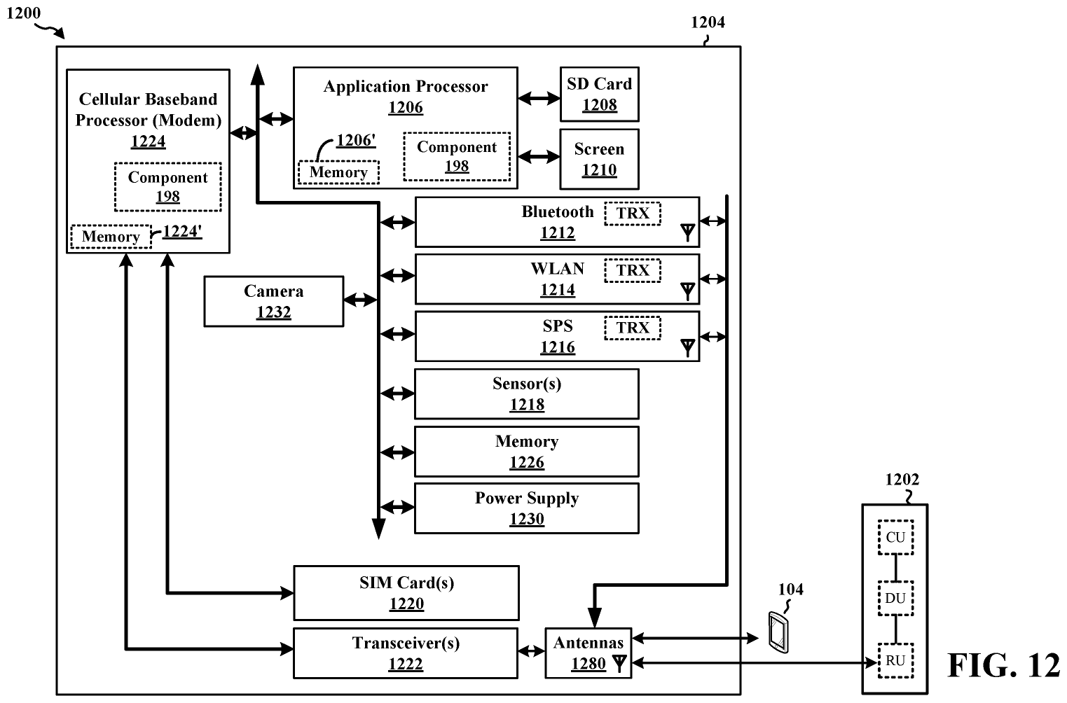

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, a satellite system module 1216 (e.g., GNSS module), one or more sensor modules 1218 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the satellite system module 1216 may include an on-chip transceiver (TRX)/receiver (RX). The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described herein. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed herein, the repetition component 198 may be configured to communicate, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission. In some aspects, the repetition component 198 may be configured to receive, from the second network entity, the first CSI-RS transmission including a first instance of CSI-RS information based on the frequency hopping pattern. In some aspects, the repetition component 198 may be configured to receive, from the second network entity, the second CSI-RS transmission including a second instance of the CSI-RS information based on the frequency hopping pattern. In some aspects, the repetition component 198 may be configured to transmit, to the second network entity, a CSI report based on the first CSI-RS transmission or the second CSI-RS transmission. The repetition component 198 may be within the cellular baseband processor 1224, the application processor 1206, or both the cellular baseband processor 1224 and the application processor 1206. The repetition component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for communicating, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission. In some aspects, the apparatus 1204 may further include means for receiving, from the second network entity, the first CSI-RS transmission including a first instance of CSI-RS information based on the frequency hopping pattern. In some aspects, the apparatus 1204 may further include means for receiving, from the second network entity, the second CSI-RS transmission including a second instance of the CSI-RS information based on the frequency hopping pattern. In some aspects, the apparatus 1204 may further include means for transmitting, to the second network entity, a CSI report based on the first CSI-RS transmission or the second CSI-RS transmission. In some aspects, the apparatus 1204 may further include means for transmitting, to the second network entity, the repetition configuration. In some aspects, the apparatus 1204 may further include means for transmitting, to the second network entity, information indicative of a set of sub-bands to sound in a BWP associated with the first CSI-RS transmission and the second CSI-RS transmission, where the repetition configuration and the set of sub-bands are based on measurement information based on a third CSI-RS transmission or a data communication, where the third CSI-RS transmission or the data communication is based on at least one sub-band of the set of sub-bands. In some aspects, the apparatus 1204 may further include means for receiving the first CSI-RS transmission in a first sub-band in a BWP. In some aspects, the apparatus 1204 may further include means for receiving the second CSI-RS transmission in a second sub-band in the BWP. In some aspects, the apparatus 1204 may further include means for receiving the first CSI-RS transmission based on a time domain RA. In some aspects, the apparatus 1204 may further include means for receiving the second CSI-RS transmission based on the time domain RA. In some aspects, the apparatus 1204 may further include means for receiving the first CSI-RS transmission in a relative RB location in the first sub-band. In some aspects, the apparatus 1204 may further include means for receiving the second CSI-RS transmission in the relative RB location the second sub-band. In some aspects, the apparatus 1204 may further include means for determining the first sub-band based on a first index associated with the first sub-band and determining the second sub-band based on a second index associated with the second sub-band. In some aspects, the apparatus 1204 may further include means for determining the second index based on the first index and the frequency hopping pattern. In some aspects, the apparatus 1204 may further include means for determining the second index based on the first index and the frequency hopping pattern. In some aspects, the apparatus 1204 may further include means for receiving, from the second network entity via downlink control information (DCI), radio resource control (RRC) signaling, or medium access control (MAC) control element (MAC-CE), the repetition configuration. In some aspects, the apparatus 1204 may further include means for determining the second sub-band based on the first index and an index difference between the first index and the second index. In some aspects, the apparatus 1204 may further include means for determining, based on measurement information associated with a particular sub-band associated with the first CSI-RS transmission and the second CSI-RS transmission, the particular sub-band. In some aspects, the apparatus 1204 may further include means for transmitting, to the second network entity, information indicative of stopping of CSI-RS transmissions. The means may be the repetition component 198 of the apparatus 1204 configured to perform the functions recited by the means. As described herein, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

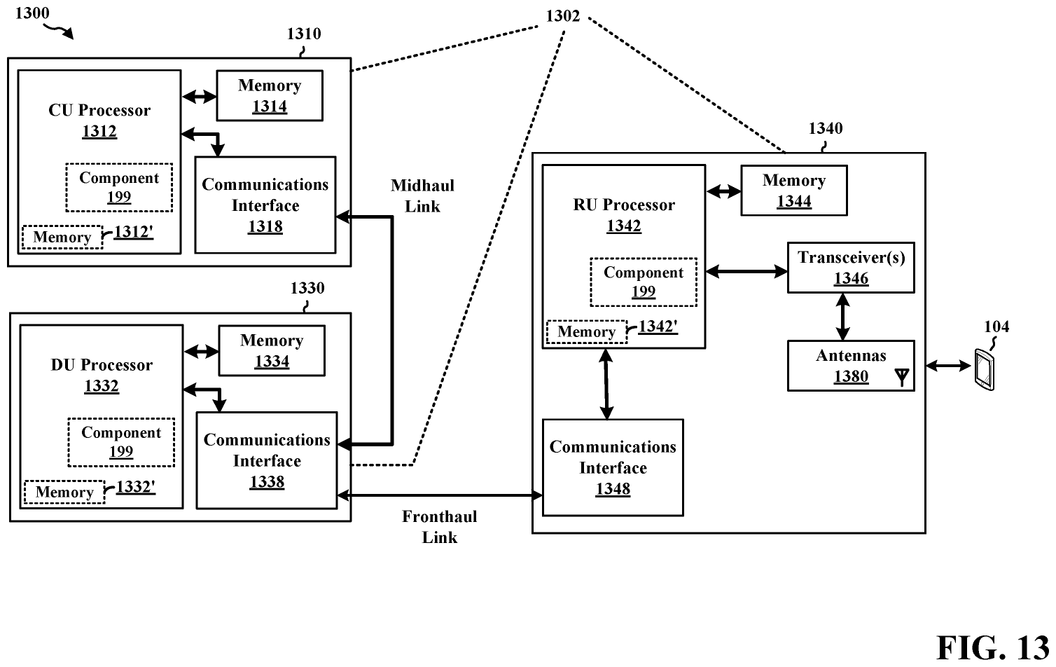

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described herein.

The computer-readable medium/memory may also be used for storing data that is manipulated by the processor(s) when executing software.

As discussed herein, the repetition component 199 may be configured to communicate, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission. In some aspects, the repetition component 199 may be further configured to transmit, for the second network entity, the first CSI-RS transmission including a first instance of CSI-RS information based on the frequency hopping pattern. In some aspects, the repetition component 199 may be further configured to transmit, for the second network entity, the second CSI-RS transmission including a second instance of the CSI-RS information based on the frequency hopping pattern. In some aspects, the repetition component 199 may be further configured to receive a CSI report based on the first CSI-RS transmission or the second CSI-RS transmission. The repetition component 199 may be within one or more processors of one or more of the CU 1310, DU 1330, and the RU 1340. The repetition component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for communicating, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission. In some aspects, the network entity 1302 may further include means for transmitting, for the second network entity, the first CSI-RS transmission including a first instance of CSI-RS information based on the frequency hopping pattern. In some aspects, the network entity 1302 may further include means for transmitting, for the second network entity, the second CSI-RS transmission including a second instance of the CSI-RS information based on the frequency hopping pattern. In some aspects, the network entity 1302 may further include means for receiving a CSI report based on the first CSI-RS transmission or the second CSI-RS transmission. The means may be the repetition component 199 of the network entity 1302 configured to perform the functions recited by the means. As described herein, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a first network entity for wireless communication, including: a memory; and at least one processor coupled to the memory, where the UE may: communicate, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission; receive, from the second network entity, the first CSI-RS transmission including a first instance of CSI-RS information based on the frequency hopping pattern; receive, from the second network entity, the second CSI-RS transmission including a second instance of the CSI-RS information based on the frequency hopping pattern; and transmit, to the second network entity, a CSI report based on the first CSI-RS transmission or the second CSI-RS transmission.

Aspect 2 is the first network entity of aspect 1, where, to communicate the repetition configuration, the UE may: transmit, to the second network entity, the repetition configuration; and transmit, to the second network entity, information indicative of a set of sub-bands to sound in a BWP associated with the first CSI-RS transmission and the second CSI-RS transmission, where the repetition configuration and the set of sub-bands are based on measurement information based on a third CSI-RS transmission or a data communication, where the third CSI-RS transmission or the data communication is based on at least one sub-band of the set of sub-bands.

Aspect 3 is the first network entity of any of aspects 1-2, where, to receive the first CSI-RS transmission, the UE may receive the first CSI-RS transmission in a first sub-band in a BWP; and to receive the second CSI-RS transmission, the UE may receive the second CSI-RS transmission in a second sub-band in the BWP.

Aspect 4 is the first network entity of aspect 3, where, to receive the first CSI-RS transmission, the UE may receive the first CSI-RS transmission based on a time domain resource allocation (RA); and to receive the second CSI-RS transmission, the UE may receive the second CSI-RS transmission based on the time domain RA.

Aspect 5 is the first network entity of aspect 3, where, to receive the first CSI-RS transmission, the UE may receive the first CSI-RS transmission in a relative RB location in the first sub-band; and to receive the second CSI-RS transmission, the UE may receive the second CSI-RS transmission in the relative RB location the second sub-band.

Aspect 6 is the first network entity of aspect 3, where the UE may: determine the first sub-band based on a first index associated with the first sub-band and determine the second sub-band based on a second index associated with the second sub-band.

Aspect 7 is the first network entity of aspect 6, where a first one of the first index or the second index is a highest index associated with the BWP, and where a second one of the first index or the second index is a lowest index associated with the BWP.

Aspect 8 is the first network entity of aspect 7, where, to determine the second sub-band based on the second index, the UE may: determine the second index based on the first index and the frequency hopping pattern.

Aspect 9 is the first network entity of aspect 7, where, to determine the second sub-band based on the second index, the UE may: determine the second index based on the first index and the frequency hopping pattern.

Aspect 10 is the first network entity of aspect 6, where, to communicate the repetition configuration, the UE may: receive, from the second network entity via downlink control information (DCI), radio resource control (RRC) signaling, or medium access control (MAC) control element (MAC-CE), the repetition configuration; and where the first sub-band is a first valid sub-band, and where, to determine the second sub-band based on the second index, the UE may: determine the second sub-band based on the first index and an index difference between the first index and the second index.

Aspect 11 is the first network entity of any of aspects 1-10, where the repetition configuration is configured per a CSI report configuration, per a CSI resource, or per a CSI resource set.

Aspect 12 is the first network entity of any of aspects 1-11, where the CSI report is based on a sub-band configured for triggering the CSI report.

Aspect 13 is the first network entity of any of aspects 1-12, where the CSI report is of a type including CSI information of at least one of: per a sub-band, per a set of sub-bands, across all sub-bands, or per one or more subset of subbands based on one or more metrics associated with the one or more subset of subbands being higher than or lower than one or more thresholds.

Aspect 14 is the first network entity of aspect 13, where a first time difference between the first CSI-RS transmission and the CSI report or a second time difference between downlink control information (DCI) scheduling the first CSI-RS transmission and the CSI report is based on at least one of: a first sub-band associated with the first CSI-RS transmission, a second sub-band associated with the second CSI-RS transmission, the type associated with the CSI report, or the frequency hopping pattern.

Aspect 15 is the first network entity of any of aspects 1-14, where the CSI report includes first measurement information associated with a first sub-band associated with the first CSI-RS transmission and second measurement information associated with a second sub-band associated with the second CSI-RS transmission, where the second measurement information is based on a difference from the first measurement information.

Aspect 16 is the first network entity of any of aspects 1-15, where the CSI report includes first measurement information associated with a first sub-band associated with the first CSI-RS transmission and second measurement information associated with a second sub-band associated with the second CSI-RS transmission, where a first priority is associated with the first measurement information and a second priority is associated with the second measurement information.

Aspect 17 is the first network entity of any of aspects 1-16, where the UE may: determine, based on measurement information associated with a particular sub-band associated with the first CSI-RS transmission and the second CSI-RS transmission, the particular sub-band; and transmit, to the second network entity, information indicative of stopping of CSI-RS transmissions.

Aspect 18 is the first network entity of any of aspects 1-17, where the CSI report includes first measurement information associated with a first sub-band associated with the first CSI-RS transmission and second measurement information associated with a second sub-band associated with the second CSI-RS transmission, where the first measurement information or the second measurement information is filtered.

Aspect 19 is the first network entity of any of aspects 1-18, where the CSI report includes information indicative of data transmission metric or positioning metric associated with each sub-band associated with the first CSI-RS transmission and the second CSI-RS transmission.

Aspect 20 is a first network entity for wireless communication, including: a memory; and at least one processor coupled to the memory, where the UE may: communicate, with a second network entity, a repetition configuration associated with a first CSI-RS transmission and a second CSI-RS transmission, where the repetition configuration includes information indicative of a frequency hopping pattern associated with the first CSI-RS transmission and the second CSI-RS transmission; transmit, for the second network entity, the first CSI-RS transmission including a first instance of CSI-RS information based on the frequency hopping pattern; transmit, for the second network entity, the second CSI-RS transmission including a second instance of the CSI-RS information based on the frequency hopping pattern; and receive a CSI report based on the first CSI-RS transmission or the second CSI-RS transmission.

Aspect 21 is the first network entity of aspect 20, where the repetition configuration is configured per a CSI report configuration, per a CSI resource, or per a CSI resource set.

Aspect 22 is the first network entity of aspect 20, where the CSI report is based on a sub-band configured for triggering the CSI report.

Aspect 23 is the first network entity of any of aspects 19-22, where the CSI report is of a type including CSI information of at least one of: per a sub-band, per a set of sub-bands, across all sub-bands, or per one or more subset of subbands based on one or more metrics associated with the one or more subset of subbands being higher than or lower than one or more thresholds.

Aspect 24 is the first network entity of aspect 23, where a first time difference between the first CSI-RS transmission and the CSI report or a second time difference between downlink control information (DCI) scheduling the first CSI-RS transmission and the CSI report is based on at least one of: a first sub-band associated with the first CSI-RS transmission, a second sub-band associated with the second CSI-RS transmission, the type associated with the CSI report, or the frequency hopping pattern.

Aspect 25 is the first network entity of any of aspects 19-24, where the CSI report includes first measurement information associated with a first sub-band associated with the first CSI-RS transmission and second measurement information associated with a second sub-band associated with the second CSI-RS transmission, where the second measurement information is based on a difference from the first measurement information

Aspect 26 is the first network entity of any of aspects 19-25, where the CSI report includes first measurement information associated with a first sub-band associated with the first CSI-RS transmission and second measurement information associated with a second sub-band associated with the second CSI-RS transmission, where a first priority is associated with the first measurement information and a second priority is associated with the second measurement information.

Aspect 27 is the first network entity of any of aspects 19-26, where the UE may: receive information indicative of stopping of CSI-RS transmissions.

Aspect 28 is the first network entity of any of aspects 19-27, where the CSI report includes first measurement information associated with a first sub-band associated with the first CSI-RS transmission and second measurement information associated with a second sub-band associated with the second CSI-RS transmission, where the first measurement information or the second measurement information is filtered.

Aspect 29 is the first network entity of any of aspects 19-28, where the CSI report includes information indicative of data transmission metric or positioning metric associated with each sub-band associated with the first CSI-RS transmission and the second CSI-RS transmission.

Aspect 30 is a method of wireless communication for implementing any of aspects 1 to 18.

Aspect 31 is an apparatus for wireless communication including means for implementing any of aspects 1 to 18.

Aspect 32 is a computer-readable medium (e.g., a non-transitory computer-readable medium) having code stored thereon that, when executed by an apparatus, causes the apparatus to implement any of aspects 1 to 18.

Aspect 33 is a method of wireless communication for implementing any of aspects 19 to 29.

Aspect 34 is an apparatus for wireless communication including means for implementing any of aspects 19 to 29.

Aspect 35 is a computer-readable medium (e.g., a non-transitory computer-readable medium) having code stored thereon that, when executed by an apparatus, causes the apparatus to implement any of aspects 19 to 29.

What is claimed is:

1. A first network entity for wireless communication, comprising:
a memory; and
at least one processor coupled to the memory, wherein the at least one processor is configured to:
communicate, with a second network entity, a repetition configuration associated with a first channel state information (CSI) reference signal (CSI-RS) transmission and a second CSI-RS transmission, wherein the repetition configuration comprises information indicative of a frequency hopping pattern associated with the first CSI-RS transmission and the second CSI-RS transmission;
receive, from the second network entity, the first CSI-RS transmission including a first instance of CSI-RS information based on the frequency hopping pattern;
receive, from the second network entity, the second CSI-RS transmission including a second instance of the CSI-RS information based on the frequency hopping pattern; and
transmit, to the second network entity, a CSI report based on the first CSI-RS transmission or the second CSI-RS transmission.

2. The first network entity of claim 1, wherein, to communicate the repetition configuration, the at least one processor is configured to:
transmit, to the second network entity, the repetition configuration; and
transmit, to the second network entity, information indicative of a set of sub-bands to sound in a bandwidth part (BWP) associated with the first CSI-RS transmission and the second CSI-RS transmission, wherein the repetition configuration and the set of sub-bands are based on measurement information based on a third CSI-RS transmission or a data communication, wherein the third CSI-RS transmission or the data communication is based on at least one sub-band of the set of sub-bands.

3. The first network entity of claim 1, wherein,
to receive the first CSI-RS transmission, the at least one processor is configured to receive the first CSI-RS transmission in a first sub-band in a bandwidth part (BWP); and
to receive the second CSI-RS transmission, the at least one processor is configured to receive the second CSI-RS transmission in a second sub-band in the BWP.

4. The first network entity of claim 3, wherein,
to receive the first CSI-RS transmission, the at least one processor is configured to receive the first CSI-RS transmission based on a time domain resource allocation (RA); and
to receive the second CSI-RS transmission, the at least one processor is configured to receive the second CSI-RS transmission based on the time domain RA.

5. The first network entity of claim 3, wherein,
to receive the first CSI-RS transmission, the at least one processor is configured to receive the first CSI-RS transmission in a relative resource block (RB) location in the first sub-band; and
to receive the second CSI-RS transmission, the at least one processor is configured to receive the second CSI-RS transmission in the relative RB location the second sub-band.

6. The first network entity of claim 3, wherein the at least one processor is configured to:
determine the first sub-band based on a first index associated with the first sub-band and determine the second sub-band based on a second index associated with the second sub-band.

7. The first network entity of claim 6, wherein a first one of the first index or the second index is a highest index associated with the BWP, and wherein a second one of the first index or the second index is a lowest index associated with the BWP.

8. The first network entity of claim 7, wherein, to determine the second sub-band based on the second index, the at least one processor is configured to:
determine the second index based on the first index and the frequency hopping pattern.

9. The first network entity of claim 7, wherein, to determine the second sub-band based on the second index, the at least one processor is configured to:
determine the second index based on the first index and the frequency hopping pattern.

10. The first network entity of claim 6,
wherein, to communicate the repetition configuration, the at least one processor is configured to: receive, from the second network entity via downlink control information (DCI), radio resource control (RRC) signaling, or medium access control (MAC) control element (MAC-CE), a hopping flag associated with the repetition configuration; and
wherein the first sub-band is a first valid sub-band, and wherein, to determine the second sub-band based on the second index, the at least one processor is configured to: determine the second sub-band based on the first index and an index difference between the first index and the second index.

11. The first network entity of claim 1, wherein the repetition configuration is configured per a CSI report configuration, per a CSI resource, or per a CSI resource set.

12. The first network entity of claim 1, wherein the CSI report is based on a sub-band configured for triggering the CSI report.

13. The first network entity of claim 1, wherein the CSI report is of a type comprising CSI information of at least one of: per a sub-band, per a set of sub-bands, across all sub-bands, or per one or more subset of subbands based on one or more metrics associated with the one or more subset of subbands being higher than or lower than one or more thresholds.

14. The first network entity of claim 13, wherein a first time difference between the first CSI-RS transmission and the CSI report or a second time difference between downlink control information (DCI) scheduling the first CSI-RS transmission and the CSI report is based on at least one of: a first sub-band associated with the first CSI-RS transmission, a second sub-band associated with the second CSI-RS transmission, the type associated with the CSI report, or the frequency hopping pattern.

15. The first network entity of claim 1, wherein the CSI report comprises first measurement information associated with a first sub-band associated with the first CSI-RS transmission and second measurement information associated with a second sub-band associated with the second CSI-RS transmission, wherein the second measurement information is based on a difference from the first measurement information.

16. The first network entity of claim 1, wherein the CSI report comprises first measurement information associated with a first sub-band associated with the first CSI-RS transmission and second measurement information associated with a second sub-band associated with the second CSI-RS transmission, wherein a first priority is associated with the first measurement information and a second priority is associated with the second measurement information.

17. The first network entity of claim 1, wherein the at least one processor is configured to:
determine, based on measurement information associated with a particular sub-band associated with the first CSI-RS transmission and the second CSI-RS transmission, the particular sub-band; and
transmit, to the second network entity, information indicative of stopping of CSI-RS transmissions.

18. The first network entity of claim 1, wherein the CSI report comprises first measurement information associated with a first sub-band associated with the first CSI-RS transmission and second measurement information associated with a second sub-band associated with the second CSI-RS transmission, wherein the first measurement information or the second measurement information is filtered.

19. The first network entity of claim 1, wherein the CSI report comprises information indicative of data transmission metric or positioning metric associated with each sub-band associated with the first CSI-RS transmission and the second CSI-RS transmission.

20. A first network entity for wireless communication, comprising:
a memory; and
at least one processor coupled to the memory, wherein the at least one processor is configured to:
communicate, with a second network entity, a repetition configuration associated with a first channel state information (CSI) reference signal (CSI-RS) transmission and a second CSI-RS transmission, wherein the repetition configuration comprises information indicative of a frequency hopping pattern associated with the first CSI-RS transmission and the second CSI-RS transmission;
transmit, for the second network entity, the first CSI-RS transmission including a first instance of CSI-RS information based on the frequency hopping pattern;
transmit, for the second network entity, the second CSI-RS transmission including a second instance of the CSI-RS information based on the frequency hopping pattern; and
receive a CSI report based on the first CSI-RS transmission or the second CSI-RS transmission.

21. The first network entity of claim 20, wherein the repetition configuration is configured per a CSI report configuration, per a CSI resource, or per a CSI resource set.

22. The first network entity of claim 20, wherein the CSI report is based on a sub-band configured for triggering the CSI report.

23. The first network entity of claim 20, wherein the CSI report is of a type comprising CSI information of at least one of: per a sub-band, per a set of sub-bands, across all sub-bands, or per one or more subset of subbands based on one or more metrics associated with the one or more subset of subbands being higher than or lower than one or more thresholds.

24. The first network entity of claim 23, wherein a first time difference between the first CSI-RS transmission and the CSI report or a second time difference between downlink control information (DCI) scheduling the first CSI-RS transmission and the CSI report is based on at least one of: a first sub-band associated with the first CSI-RS transmission, a second sub-band associated with the second CSI-RS transmission, the type associated with the CSI report, or the frequency hopping pattern.

25. The first network entity of claim 20, wherein the CSI report comprises first measurement information associated with a first sub-band associated with the first CSI-RS transmission and second measurement information associated with a second sub-band associated with the second CSI-RS transmission, wherein the second measurement information is based on a difference from the first measurement information.

26. The first network entity of claim 20, wherein the CSI report comprises first measurement information associated with a first sub-band associated with the first CSI-RS transmission and second measurement information associated with a second sub-band associated with the second CSI-RS transmission, wherein a first priority is associated with the first measurement information and a second priority is associated with the second measurement information.

27. The first network entity of claim 20, wherein the CSI report comprises first measurement information associated with a first sub-band associated with the first CSI-RS transmission and second measurement information associated with a second sub-band associated with the second CSI-RS transmission, wherein the first measurement information or the second measurement information is filtered.

28. The first network entity of claim 20, wherein the CSI report comprises information indicative of data transmission metric or positioning metric associated with each sub-band associated with the first CSI-RS transmission and the second CSI-RS transmission.

29. A method for wireless communication performed by a first network entity, comprising:
communicating, with a second network entity, a repetition configuration associated with a first channel state information (CSI) reference signal (CSI-RS) transmission and a second CSI-RS transmission, wherein the repetition configuration comprises information indicative of a frequency hopping pattern associated with the first CSI-RS transmission and the second CSI-RS transmission;
receiving, from the second network entity, the first CSI-RS transmission including a first instance of CSI-RS information based on the frequency hopping pattern;
receiving, from the second network entity, the second CSI-RS transmission including a second instance of the CSI-RS information based on the frequency hopping pattern; and
transmitting, to the second network entity, a CSI report based on the first CSI-RS transmission or the second CSI-RS transmission.

30. A method for wireless communication performed by a first network entity, comprising:
communicating, with a second network entity, a repetition configuration associated with a first channel state information (CSI) reference signal (CSI-RS) transmission and a second CSI-RS transmission, wherein the repetition configuration comprises information indicative of a frequency hopping pattern associated with the first CSI-RS transmission and the second CSI-RS transmission;
transmitting, for the second network entity, the first CSI-RS transmission including a first instance of CSI-RS information based on the frequency hopping pattern;
transmitting, for the second network entity, the second CSI-RS transmission including a second instance of the CSI-RS information based on the frequency hopping pattern; and
receiving a CSI report based on the first CSI-RS transmission or the second CSI-RS transmission.
